(19) United States
(12) Patent Application Publication
(10) Pub. No.: US 2006/0010245 A1
(43) Pub. Date: Jan. 12, 2006

(54) Internet protocol for the delivery of complex digital media content

(75) Inventor: Shawn Carnahan, Nevada City, CA (US)

Correspondence Address: DLA PIPER RUDNICK GRAY CARY US, LLP, 2000 UNIVERSITY AVENUE, E. PALO ALTO, CA, 94303-2248, US

(73) Assignee: Telestream, Inc.

(21) Appl. No.: 11/142,048

(22) Filed: May 31, 2005

Related U.S. Application Data
(60) Provisional application No. 60/575,934, filed on Jun. 1, 2004.
(60) Provisional application No. 60/575,935, filed on Jun. 1, 2004.
(60) Provisional application No. 60/575,936, filed on Jun. 1, 2004.

(51) Int. Cl. G06F 15/16

(52) U.S. Cl. 709/231

(57) ABSTRACT

A Portable Media Protocol (PMP) is disclosed which reliably and efficiently transfer content across the Internet. The protocol is operated by Internet hardware apparatus for the delivery of complex digital media content from a sending end point to a receiving end point by session participation as multiple and separate aspects, the protocol comprising a transport layer implemented by a sequence field, a request field and a receipt field, and an application layer represented by the session field.

### RELATED APPLICATIONS

Priority is claimed to Provisional Application Ser. Nos. 60/575,934 filed on Jun. 1, 2004, 60/575,935 filed on Jun. 1, 2004 and 60/575,936 filed on Jun. 1, 2004, each incorporated herein by reference.

### BACKGROUND OF THE INVENTION

A Portable Media Protocol (PMP) is disclosed which is designed to reliably and efficiently transfer content from a transmitting device within a first hardware apparatus to a receiving device within a second hardware apparatus, across the Internet. Relatedly, transmissions will be transmitted from a transmitting device within said second hardware apparatus and received by a receiving device within said first hardware apparatus, across the Internet. While this protocol is applicable to a variety of data types and applications, it specifically addresses the challenge of transporting large, complex digital media content. The general requirements and limitations of existing protocols and the unique functionality provided by PMP are described.

### BRIEF DESCRIPTION OF THE DRAWINGS

FIG. 1 is an illustrative diagram of a PMP packet.

FIG. 2 illustrates the operation of the PMP protocol between a client application and a server application.

### RELIABILITY

Like all Internet communication schemes, PMP builds upon Internet Protocol (IP). IP is a routing protocol; it defines the addressing scheme used within the Internet and routes data packets between network end points.

IP is also a connectionless protocol, which means that it does not exchange control information between the end points before packets are transmitted. Because it provides no error detection or recovery mechanisms, IP is often referred to as an unreliable protocol.

IP relies on a transport layer protocol, such as Transmission Control Protocol (TCP), to establish a connection between the end points and provide a reliable data stream.

Once a reliable connection has been established, application layer protocols such as File Transfer Protocol (FTP) and HyperText Transfer Protocol (HTTP) allow the end points to participate in a session.

PMP combines both transport and application layers within a single protocol. PMP creates a reliable connection between the end points and establishes a session which is shared by the communicating applications.

Efficiency

A reliable protocol should detect and recover from the loss, duplication or incorrect sequencing of data packets. Packet loss is typically caused by congestion in the devices that route data packets through the network. Packet loss may be ambient; caused by other traffic present in the routers, or induced by the traffic being exchanged between the communicating end points. In either case, packet loss degrades the rate at which information is exchanged between the end points.

An efficient protocol should implement a mechanism for avoiding congestion while maximizing the data transfer rate. While TCP is a reliable transport protocol, it is not necessarily an efficient one. As packet loss increases, the congestion avoidance mechanism causes the transfer rate to decreases geometrically. While this is generally not an issue for small amounts of data, it can have a significant impact on the time required to transport large media content. In contrast, PMP implements a flow control mechanism that avoids congestion and degrades linearly in the presence of ambient packet loss. This helps ensure that content is transferred at the maximum rate possible for a given network connection. This can be contrasted with other protocols that do not degrade linearly. PMP has as an object that if the system loses ten percent of the packets, then ninety percent of the packets will be provided. Other protocols are designed such that a loss of, say, ten percent of the packets results in much less than ninety percent of the packets being provided.

Connection Tolerance

Connection oriented protocols such as TCP are designed to tolerate a relatively small percentage of packet loss; they are not tolerant of a complete loss of network connectivity. If the physical network is disrupted the connection between the end points is irrevocably severed and any application protocol using that data stream will eventually fail.

Network disruptions can be caused by simply disconnecting an end point from the network or by a failure in some portion of the network infrastructure. Wireless networks are particularly prone to disruption due to RF interference and line of sight obstructions. PMP is tolerant of network disruptions; once a session is established it is independent of the connection currently used to transport data between the end points.

Network Portability

Following a network disruption it is possible that an end point will reconnect to the network at an entirely different IP address. This might be caused by a DHCP server assigning a new address to the end point or because the end point physically moved to a different network.

After a session has been established, PMP allows either end point to move to a different network address. A beacon mechanism allows the end points to find each other following a network disruption, reestablish a reliable connection and continue the existing session.

Content Complexity

The primary purpose of PMP is to reliably and efficiently transport large, complex content between two network end points. In this context, complex means that the content is comprised of more than one aspect. For example, a file transported using FTP has two aspects; the file name and the file data.

PMP extends this concept by allowing the content to be transported as multiple and separable aspects. An aspect might be used to transport the content essence or the metadata that describes the essence. Aspects may also be used to transport multiple related items, for example, the files contained within a folder as discussed in U.S. patent application serial number not yet assigned filed on even date herewith and assigned to the common assignee.

### DETAILED DESCRIPTION

Packet

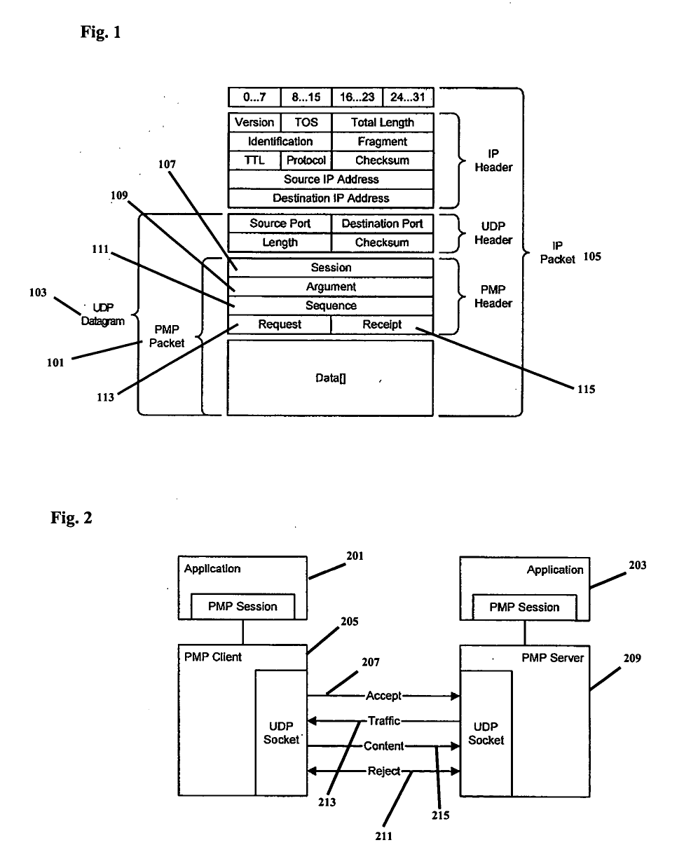

PMP employs the User Datagram Protocol (UDP) as its basic transport service. UDP is a connectionless, unreliable protocol; the only services it provides above IP are checksum protection of the datagram and multiplexing by port number (similar to TCP). As shown diagrammatically in FIG. 1, each PMP packet 101, which can be considered a signal, is transported within a UDP datagram 103 which is in turn transported within an IP packet 105. In one example, a PMP packet 101 comprises a 16 byte header followed by a variable length array of data bytes.

Tables

Certain of the tables below illustrate how the argument of a particular packet is to be interpreted. For example, the session field determines the packet type. Table 1 shows that the argument within the packet is to be interpreted as a message, as control, or as content. If the packet is a message, Table 2 shows that the argument is interpreted as an accept signal, a beacon signal or a reject signal. If the packet is a content packet, Table 4 shows that the argument is to interpreted as an aspect signal or a traffic signal. This will be discussed in more detail below.

Session

The session field 107 in FIG. 1 is illustratively a 32 bit signed integer which determines the meaning of the packet and the session to which the packet belongs. The absolute value of this field 107 is the unique identifier assigned to the session. A negative field value indicates that the packet contains a message for the session. Messages are used to establish and terminate sessions and to reconnect a session following a network disruption. As seen in Table 1, a value of zero indicates that the packet contains a control message. Controls are used to exchange information that is independent of any specific session (protocol version, encryptions keys, and the like).

Session and control messages are atomic; the signal and data that comprise the message are contained and transported within a single packet. Messages are also connectionless; their delivery is not guaranteed nor are they explicitly acknowledged by the receiver.

A positive field value for session 107 of FIG. 1, and in Table 1, indicates that the packet is transporting content for the session.

Session content is a stream; the content is segmented into multiple packets by the sender and re-assembled in the correct order by the receiver. Content packets are explicitly requested and acknowledged and are subject to flow control and congestion avoidance.

TABLE 1
Session

| Value | Signal | Description |
|---|---|---|
| −S | message | The packet contains a message for the session |
| | | identified by the value S. Messages are used |
| | | to establish a session or terminate a session |
| | | when an error occurs. |
| 0 | control | The packet contains a control signal. Controls |
| | | allow the end points to exchange information |
| | | that is independent of any specific session. |
| +S | content | The packet contains content for the session |
| | | identified by the value S. |

Argument

The argument field 109 of FIG. 1 is illustratively a 32 bit signed integer which further describes the packet. The format of this field depends on whether the packet contains a control signal, a session message or session content.

Message Argument

Within a message packet the argument field 109 contains a signal as described in Table 2, below.

TABLE 2
Message Argument

| Value | Signal | Description |
|---|---|---|
| >0 | Accept | The sender is attempting to establish a new |
| | | session with the receiver. The packet data |
| | | contains a list of length-prefixed argument |
| | | strings required to authenticate the sender. |
| 0 | Beacon | This signal is sent periodically to inform |
| | | the receiver of the sender's current location. |
| | | When this signal is received the UDP/IP |
| | | headers contain the current port number |
| | | and IP address of the sender. The packet |
| | | need contain no other data. |
| <0 | Reject | The sender is rejecting the creation of a |
| | | new session due to an unsupported authenti- |
| | | cation scheme or invalid credentials. This |
| | | signal is also used to indicate that the |
| | | sender is terminating an existing session |
| | | due to an unrecoverable error or that the |
| | | session has been closed. |
| | | The packet data can contain a |
| | | length-prefixed string describing the |
| | | error or reason for the rejection. |

In order to establish a session the server must authenticate the identity of the client using the credentials supplied in the accept message packet. This packet contains a list of length-prefixed strings that represent the arguments for the authentication process.

For all authentication schemes the first argument contains the scheme identifier, which would normally be case insensitive. The second argument is the fully qualified Uniform Resource Identifier (URI) that the client is attempting to access. The remaining arguments are defined by the specific scheme and are described in Table 3, below.

TABLE 3
Accept Schemes

| Scheme | Description |
|---|---|
| anonymous | Anonymous access: a username and |
| | password are not required. |
| | utf8 (“anonymous”) |
| | utf8 (uri) |
| | base64 (utf8 (email)) |
| base64 | Basic Authentication: the packet |
| | contains the client's username and |
| | password. |
| | utf8 (“BASE64”) |
| | utf8 (uri) |
| | base64 (utf8 (username)) |
| | base64 (utf8 (password)) |
| | The basic authentication scheme is non- |
| | secure since the client's |
| | username and password are transmitted |
| | in clear text (obscured only by |
| | the base64 encoding). |
| rsa | Secure Authentication: the packet |
| | contains the client's username and |
| | password encrypted using the server's |
| | public RSA key. |
| | utf8 (“RSA”) |
| | utf8 (uri) |
| | base64 (rsa (utf8 (username))) |
| | base64 (rsa (utf8 (password))) |
| rsa3des | Secure Authentication and Content: |
| | the packet contains the client's |
| | username and password. The packet |
| | also contains the DES3 key and |
| | initial value (IV) the client will |
| | use to encrypt each content packet. Each |
| | argument is encrypted using the |
| | server's public RSA key. |
| | utf8 (“RSA3DES”) |
| | utf8 (uri) |
| | base64 (rsa (utf8 (username))) |
| | base64 (rsa (utf8 (password))) |
| | base64 (rsa (key)) |
| | base64 (rsa (iv)) |

Content Argument

Within a content packet the argument field 109 further defines the type of data contained in the packet as shown in Table 4.

TABLE 4
Content Argument

| Value | Type | Description |
|---|---|---|
| +A | Aspect | The packet contains data for a particular |
| | | aspect of the content. The absolute value |
| | | of this field (A) indicates the specific |
| | | aspect type being transported. |
| −A | Aspect | The packet represents the end of a |
| | | particular content aspect stream. The |
| | | absolute value of this field (A) indicates |
| | | the specific aspect being closed. The |
| | | packet may be empty or contain the final |
| | | data associated with the content aspect. |
| 0 | Traffic | The packet represents a request for content |
| | | data. This type of packet controls the |
| | | flow of content packets between the |
| | | end points and is referred to as a |
| | | traffic packet. |
| −0 | Traffic | The packet represents the end of the |
| | | content stream. When this packet has |
| | | been successfully exchanged, the session is |
| | | closed. |

A content stream is logically composed of one or more separate aspect streams. A simple file transfer involves two aspects: the file name and the data contained in the file. Media content may consist of separate video and audio aspects or separate essence and metadata aspects. In any case, each aspect is delivered within a unique aspect stream.

The aspect field value identifies the specific type of content data being transported by the packet. Table 5 describes the standard aspect types.

TABLE 5
Standard Aspect Types

| Value | Type | Description |
|---|---|---|
| 1 | Uuid | The aspect stream contains a 128 bit |
| | | Universally Unique Identifier (UUID) |
| | | associated with the content. A UUID is |
| | | typically used to identify the content |
| | | within a database. |
| 2 | Name | The aspect stream contains a length- |
| | | prefixed string representing the name |
| | | of the content. The name may represent |
| | | the file in which the content was stored |
| | | or a description of the content. |
| 3 | Data | The aspect stream contains binary data |
| | | that represents the essence of the content. |

An application may define additional aspect types so long as they do not conflict with those assigned by other applications.

If an end point does not implement a particular content aspect it should discard the packet. An end point may not reject a session because it contains an unrecognized aspect stream.

Multiple content aspects may be delivered sequentially or concurrently and in any order. For example, separate video and audio aspect streams may be delivered concurrently by multiplexing the associated content packets.

A content stream may also contain multiple aspects of the same type. In this case, each aspect stream is assigned a unique parcel identifier. The aspect, type and parcel values are related by the following equation:
aspect=(parcel<<16)+type.

The parcel identifier allows different content aspects to be grouped together. For example, if the content comprises multiple files, each file would be assigned a unique parcel identifier. Each parcel would then contain separate name and data aspects.

Control Argument

Within a control packet the argument field contains a signal as described in Table 6.

In general, a positive value indicates a request for information and a negative value indicates a response to a previous request. Arguments for a specific signal can be contained in the packet as a list of length-prefixed strings.

TABLE 6
Control Argument

| Value | Signal | Description |
|---|---|---|
| +1 | +version | The send is requesting the protocol |
| | | version implemented by the receiver. |
| | | The request has no arguments. |
| −1 | −version | The packet contains the protocol |
| | | version implemented by the sender: |
| | | Utf8 (“1.0.0”) |
| +2 | +key | The sender is requesting the RSA |
| | | public key of the receiver. |
| | | The request has no arguments. |
| −2 | −key | The packet contains the sender's |
| | | RSA public key: |
| | | base64 (key) |
| | | The RSA public key is typically |
| | | used to encrypt the authentication |
| | | credentials required to establish |
| | | a session with the sender. |

Sequence

The sequence field 111 of FIG. 1 is illustratively a 32 bit unsigned integer that specifies the order or sequence of content packets. This field is used to detect the loss or duplication of content packets and to reassemble packets in the correct order.

Within a traffic packet this is used to indicate the range of content sequences that have been successfully received by the sender and the range of new content sequences being requested by the sender.

Request

The request field 113 of FIG. 1 is illustratively a 16 bit unsigned integer which (when added to the sequence field) indicates the number of consecutive content sequences being requested. Within a traffic packet this field indicates that the sender is explicitly requesting all content sequences up to but excluding the sequence number computed by: sequence+request.

Receipt

The receipt field 115 is illustratively a 16 bit unsigned integer which (when subtracted from the sequence field) indicates the number of content sequences that have been successfully received. Within a traffic packet this field indicates that the sender has successfully received all content sequences up to but excluding the sequence number computed by: sequence-receipt.

Operation

FIG. 2 illustrates a PMP session, conducted between a client application 201 and a server application 203. The client application and the server application may be considered the end points in this example.

Session Establishment

The client 205 begins by sending a +key control message to the server 209. This message is sent periodically until the server responds with a −key control containing its public encryption key. If the server is unwilling to reveal its public key the client must obtain it through some other mechanism or use a non-secure authentication scheme.

The client application 201 creates a new session. The client 205 assigns a unique identifier to the session (field 107 of FIG. 1) which is used for all subsequent packets exchanged between the end points.

The client 205 sends an accept message 207 containing the authentication credentials which have been encrypted using the server's public key. The credentials are secure since they can only be decoded using the server's public key. The accept message is sent periodically until a response is received from the server 209 or the client application 201 closes the session.

If, for any reason (unsupported authentication scheme, invalid credentials, etc.), the server application 203 is unwilling to accept the session, the server 209 responds with a reject message 211 describing the reason. The client 205 terminates the session and informs the client application accordingly.

If the session is accepted the server 209 responds with a +traffic packet request 213 for the first content packet (sequence=0) at 213. The response of the client 205 to the +traffic request is the client sending the requested content. The server 209 then informs the server application 203 that it may begin reading the content stream. The traffic packet is sent periodically until a response is received from the client 205.

If request=1 then packets are requested one at a time (this is also the slowest transfer rate), with request>1 the channel becomes more efficient.

Content Transfer

The client 205 receives the initial traffic request 213 and informs the client application 201 that it may begin writing to the content stream. The client application 201 opens one or more streams for specific content aspects and begins writing data to those streams.

When sufficient data is available from the client application 203, the client 205 sends the initial content+aspect sequence for each stream. The client continues to send content sequences as data is received from the application.

When the client application 201 has finished writing a particular aspect and closes the stream, the client 205 sends the content—aspect sequence to the server 209.

When the client application 201 has finished writing all data to the content stream it closes the session. The client 205 sends the content—traffic sequence to the server 209 and then waits for that sequence to be acknowledged.

The server 209 continues to send traffic packets until all content sequences (including the content—traffic sequence) have been received and consumed by the application 201.

Flow Control

Data received from the client application 201 is segmented into packets. The sequence field is incremented for each packet and the argument field is initialized based on the aspect stream to which the data belongs.

A specific packet size is not mandatory. The optimal packet size for a given application will be a function of packet overhead and the fragmentation imposed by the physical network layers. Since a packet may only contain data from a single aspect stream content packets are not always a fixed size.

A content packet is sent by the client 205 only when the sequence number is explicitly requested by a traffic packet from the server 209. The client retains a content packet until the receipt of the sequence number has been explicitly acknowledged by a traffic packet from the server 209. That is, when a +traffic packet is sent by server 209 to a client 205, it is EXPLICITLY requesting all content packets from the client with sequence numbers in the range:
sequence:sequence+request.

It is also explicitly acknowledging all content sequences in the range:
0: sequence—receipt, and
it is IMPLICITLY requesting content sequences in the range of:
sequence−receipt: sequence
in that it is still waiting for some of the content sequences but has already issued at least one explicit request for them.

Assuming no packet loss in the network the data transfer rate will be at a minimum when request=1, i.e., requesting one packet per request. In this case the data rate is a function of packet size and the latency between sending a traffic request and receiving the corresponding content packet. The data rate increases with larger request values, i.e., increasing additional packets per request, until the network becomes saturated and packet loss is induced. That is, appropriate hardware in the client 205 increases the value of request 113 in order to increase the data rate, which the client monitors as the data rate increases, until increased the data rate induces packet loss. Thus the client tries to exchange data as fast as possible, with no packet loss, guaranteeing correct operation, within the packet and protocol constraints.

If a content sequence (or traffic request) is lost by the network, the server 209 will eventually send another traffic packet requesting the missing content sequences. Lost packets can be detected based on measured round trip packet latency and sequence number delays. With accurate detection, the data rate will decrease linearly as ambient packet loss increases.

Content packets received by the server 209 are reassembled in the correct order based on the sequence field. The content stream is de-multiplexed into separate aspect streams and then consumed by the server application 203

Session Recovery

PMP is tolerant of network disruptions including extended loss of connectivity and address relocation of either endpoint:

If the network is disrupted the server 209 will fail to receive the requested content sequences. The packet loss will cause the server to periodically send +traffic packets requesting the incomplete content sequences.

When the client 205 fails to receive traffic packets it will begin periodically sending beacon messages, discussed above with respect to Table 2, to the server 209. The purpose of the beacon signal is to associate a session identifier with the sender's current network address.

When the network is restored, the server 209 examines the received beacon message. If the client's network address has changed during the network disruption, the server begins sending the traffic requests to the new location.

Likewise, client 205 examines the traffic packets to determine whether the server's network address changed during the network disruption. If so, the client revises the address accordingly. If both end points are relocated following the disruption the session cannot be restored and will eventually time out.

Session Termination

When the client 205 finally receives a receipt for the −traffic sequence it considers the corresponding session to be closed. The client sends a reject message 211 in response to any subsequent packets for the session.

After the server 209 receives the −traffic sequence it considers the corresponding session to be closed. However, the server continues to send traffic receipts until a reject message is received for the session indicating the client 205 has also closed the session.

Lifetime

Once a session has been established, it exists until one of the following conditions occurs:
The content has been transferred successfully and the client 205 closes the session.
An unrecoverable error occurs within the client or server 209 and that end point closes the session.
The session expires. Expiration rules are application dependant and may be based on a maximum duration or absolute time (deadline).

While the foregoing has been with reference to particular embodiments of the invention, it will be appreciated by those skilled in the art that changes in these embodiments may be made without departing from the principles and spirit of the invention.

I claim:

1. An electrical signal for use in the delivery of complex digital media content from a sending end point having a first network address to a receiving end point having a second network address, the delivery being over the Internet in an Internet session having a session identifier and in response to a request from the receiving end point,
the electrical signal comprising a beacon signal transmitted by the sending end point to the receiving end point,
the beacon signal associating the session identifier signal and the first network address,
the beacon signal being sent in response to the sending end point failing to receive the request from the receiving end point due to a network disruption.

2. An Internet information packet signal for transporting content sequences over the Internet in an Internet session from a sending end point having a first network address, to a receiving end point having a second network, the content including one or more aspect streams, the signal implemented in protocol versions by the sending end point and in protocol versions by the receiving end point, the signal comprising:
a session signal transmitted by the sending end point for signaling that the packet contains a message signal, a control signal or a content signal, and identifying the session to which the packet belongs;
a sequence signal transmitted by the sending end point for specifying the order sequence of the content sequences;
a request signal transmitted by the receiving end point for indicating the number of consecutive content sequences being requested from the sending end point; and
a receipt signal transmitted by the receiving end point for indicating the number of content sequences that have been successfully received by the receiving end point.

3. The signal of claim 2 wherein the session signal contains:
digital information decodable by a decoder to indicate that the packet contains a message signal; and
an argument signal including:
an accept signal decodable by a decoder as indicating that the sending end point is attempting to establish a new session with the receiving end point;
a beacon signal decodable by a decoder as including information identifying the first network address; and
a reject signal decodable by a decoder as information indicating the receiving end point is rejecting the creation of a new session.

4. The signal of claim 2 wherein the content signal contains:
digital information decodable by a decoder to indicate that the packet contains a content signal; and
an argument signal including:
a positive aspect signal decodable by a decoder as information indicating the packet contains data for a particular aspect of the content;
a negative aspect signal decodable by a decoder as information indicating that the packet represents the end of a content aspect stream;
a positive traffic signal decodable by a decoder as information indicating that the packet is a request for content data; and
a negative traffic signal decodable by a decoder as information indicating that the packet is the final packet in a content aspect stream.

5. The signal of claim 2 wherein the sending end point has a first security key and the receiving end point has a second security key, and the control signal contains:
digital information decodable by a decoder to indicate that the packet contains a control signal; and
an argument signal including:
a positive version signal decodable by a decoder as information indicating that the sending end point is requesting the protocol version implemented by the receiving end point;
a negative version signal decodable by a decoder as information indicating the packet contains the protocol version implemented by the sender end point;
a positive key signal decodable by a decoder to indicate the sending end point is requesting the second security key; and
a negative key signal decodable by a decoder to indicate that the packet contains the first security key.

6. The process of establishing an Internet session for sending content between a client and a server, each of the client and the server having its own security key, the process including:
the client periodically sending a positive key control message to a server;
the client receiving from the server a negative key control message and the server's security key;
the client creating a new Internet session and assigning a unique identifier to the session;
the client sending an accept message to the server, the accept message encrypted for the server;
the client receiving from the server a response to the accept message and, in response to receiving the response, the server periodically sending the server a positive traffic packet request for content from the client.

7. The process of transferring content between a client and a server in a content stream over the Internet, the client having associated therewith a client application, and the server having associated therewith a server application, the process including:
the client receiving an initial traffic request for content from the server and informing the client application to begin writing to the content stream;
the client opening one or more content streams for specific content aspects and writing data to the one or more streams;
the client sending an initial content positive aspect sequence for each the one or more streams;
the client continuing to send content-aspect sequences from the client application responsive to acknowledgement of content-aspect sequence reception from the server; and
the client application closing the session upon completion of writing all data to the content stream.

8. A data rate control process for controlling the data rate of data transmitted in a data transmission process having a measurable data rate, the data being transmitted between a client and a server in a content stream, the data having multiple aspect streams, the client having associated therewith a client application, the data transmitted in a signal including a session field, an argument field, a sequence field containing a sequence number, a request field and a receipt field, wherein the data transmission process includes:
the client segmenting data received from the client application into packets;
the client incrementing the sequence field for each the packet;
the client initializing the argument field based on the aspect stream to which the data belongs;
the client sending a content packet in response to receiving an explicit request field for the sequence number of the packet from the server, the explicit request field including the number of packets to be transmitted by the client;
the client sending no further content packet until the client receives a receipt field from the server acknowledging that the sequence number has been received by the server;
the data rate control process including:
the server continually increasing the number of packets requested in the explicit request while monitoring the measurable data rate to detect when the increased number of packets induces packet loss.

9. The data rate control process of claim 8 wherein, in response to loss of a content sequence, the server sends another request to the client for the missing content sequence, the packet loss being detected by measuring round trip packet latency between the server and the client, and sequence number delays.

10. The data rate control process of claim 8 wherein in response to detecting packet loss the server ceases to increase the number of packets requested in the explicit request.

11. A data rate control process for controlling the data rate of data transmitted over a communication channel in a data transmission process having a measurable data rate, the data being transmitted in a content stream between a sender and a receiver in response to an explicit request by the receiver for a specific quantity of data, the data rate control process including the receiver continually increasing the quantity of data requested in the explicit request while monitoring the measurable data rate to detect when the increased quantity of data induces data loss.

12. A data rate control process for controlling the data rate of data transmitted over the Internet in a data transmission process having a measurable data rate, the data being transmitted in a content stream of data packets between a client and a server in response to an explicit request by the server for a specific quantity of data packets, the data rate control process including the server continually increasing the quantity of data packets requested in the explicit request while monitoring the measurable data rate to detect when the increased quantity of data packets induces packet loss.

13. A recovery process for recovering an Internet data packet transmission session, after resolution of a network disruption, in a session between a client having a client network address and a server having a server network address, the server receiving the content sequences from the client in response to explicit requests for the content sequences, wherein the network disruption is caused by loss of connectivity between the client and server or by network address relocation of either of the client or the server, and wherein the data packets include content sequence, a session identifier signal for identifying the session and a beacon signal associating the session identifier signal with the client network address, the recovery process comprising:
the server, in response to failing to receive requested content sequences due to the network disruption, periodically sending an expected request signal to the client for the content sequences;
the client, in response to failing to receive the expected request signal, periodically sending the beacon signal to the server, the beacon signal associating the session identifier with the current client network address;
after resolution of the network disruption, the server examining the received beacon signal and sending the expected request signal for the requested content sequences to the current client address in the beacon signal;
the client examining the request signal from the server, the request signal including the current server network address, and
the client sending the requested content sequence to the current server network address.

14. A recovery process for recovering an Internet data packet transmission session, after resolution of a network disruption, in a session between a client having a client network address and a server having a server network address, the server receiving the content sequences from the client in response to explicit requests for the content sequences, wherein the network disruption is caused by loss of connectivity between the client and server or by network address relocation of either of the client or the server, and wherein the data packets include content sequence, a session identifier signal for identifying the session and a beacon signal associating the session identifier signal with the client network address, the recovery process comprising:
the client sending the beacon signal to the client in response to the client failing to receive an expected request from the server for content sequence.

15. An Internet protocol operated by Internet hardware apparatus for the delivery of complex digital media content from a sending end point to a receiving end point by session participation as multiple and separate aspects, the protocol comprising a transport layer implemented by a sequence field, a request field and a receipt field, and an application layer represented by the session field.

16. An Internet protocol operated by Internet hardware for the delivery of complex digital media content from a sending end point having a first network address to a receiving end point having a second network address, by participation in an Internet session having a session identifier, the protocol including a beacon signal associating the session identifier and the first network address, for allowing the receiving end point and the sending end point to reestablish connection and continue the session after a network disruption.

17. One or more processor readable storage devices having processor readable code embodied on said processor readable storage devices, said processor readable code for programming one or more processors to perform a method of establishing an Internet session for sending content between a client and a server, each of the client and the server having its own security key, the process including:
the client periodically sending a positive key control message to a server;
the client receiving from the server a negative key control message and the server's security key;
the client creating a new Internet session and assigning a unique identifier to the session;
the client sending an accept message to the server, the accept message encrypted for the server;
the client receiving from the server a response to the accept message and, in response to receiving the response, the server periodically sending the server a positive traffic packet request for content from the client.

18. One or more processor readable storage devices having processor readable code embodied on said processor readable storage devices, said processor readable code for programming one or more processors to perform a method of transferring content between a client and a server in a content stream over the Internet, the client having associated therewith a client application, and the server having associated therewith a server application, the process including:
the client receiving an initial traffic request for content from the server and informing the client application to begin writing to the content stream;
the client opening one or more content streams for specific content aspects and writing data to the one or more streams;
the client sending an initial content positive aspect sequence for each the one or more streams;
the client continuing to send content-aspect sequences from the client application responsive to acknowledgement of content-aspect sequence reception from the server; and
the client application closing the session upon completion of writing all data to the content stream.

19. One or more processor readable storage devices having processor readable code embodied on said processor readable storage devices, said processor readable code for programming one or more processors to perform a method of controlling the data rate of data transmitted in a data transmission process having a measurable data rate, the data being transmitted between a client and a server in a content stream, the data having multiple aspect streams, the client having associated therewith a client application, the data transmitted in a signal including a session field, an argument field, a sequence field containing a sequence number, a request field and a receipt field, wherein the data transmission process includes:
the client segmenting data received from the client application into packets;
the client incrementing the sequence field for each the packet;
the client initializing the argument field based on the aspect stream to which the data belongs;
the client sending a content packet in response to receiving an explicit request field for the sequence number of the packet from the server, the explicit request field including the number of packets to be transmitted by the client;
the client sending no further content packet until the client receives a receipt field from the server acknowledging that the sequence number has been received by the server;
the data rate control process including:
the server continually increasing the number of packets requested in the explicit request while monitoring the measurable data rate to detect when the increased number of packets induces packet loss.

20. The one or more processor readable storage devices of claim 19 wherein, in response to loss of a content sequence, the server sends another request to the client for the missing content sequence, the packet loss being detected by measuring round trip packet latency between the server and the client, and sequence number delays.

21. The one or more processor readable storage devices of claim 19 wherein in response to detecting packet loss the server ceases to increase the number of packets requested in the explicit request.

22. One or more processor readable storage devices having processor readable code embodied on said processor readable storage devices, said processor readable code for programming one or more processors to perform a method of controlling the data rate of data transmitted over a communication channel in a data transmission process having a measurable data rate, the data being transmitted in a content stream between a sender and a receiver in response to an explicit request by the receiver for a specific quantity of data, the data rate control process including the receiver continually increasing the quantity of data requested in the explicit request while monitoring the measurable data rate to detect when the increased quantity of data induces data loss.

23. One or more processor readable storage devices having processor readable code embodied on said processor readable storage devices, said processor readable code for programming one or more processors to perform a method of controlling the data rate of data transmitted over the Internet in a data transmission process having a measurable data rate, the data being transmitted in a content stream of data packets between a client and a server in response to an explicit request by the server for a specific quantity of data packets, the data rate control process including the server continually increasing the quantity of data packets requested in the explicit request while monitoring the measurable data rate to detect when the increased quantity of data packets induces packet loss.

24. One or more processor readable storage devices having processor readable code embodied on said processor readable storage devices, said processor readable code for programming one or more processors to perform a method of recovering an Internet data packet transmission session, after resolution of a network disruption, in a session between a client having a client network address and a server having a server network address, the server receiving the content sequences from the client in response to explicit requests for the content sequences, wherein the network disruption is caused by loss of connectivity between the client and server or by network address relocation of either of the client or the server, and wherein the data packets include content sequence, a session identifier signal for identifying the session and a beacon signal associating the session identifier signal with the client network address, the recovery process comprising:
the server, in response to failing to receive requested content sequences due to the network disruption, periodically sending an expected request signal to the client for the content sequences;
the client, in response to failing to receive the expected request signal, periodically sending the beacon signal to the server, the beacon signal associating the session identifier with the current client network address;
after resolution of the network disruption, the server examining the received beacon signal and sending the expected request signal for the requested content sequences to the current client address in the beacon signal;
the client examining the request signal from the server, the request signal including the current server network address, and
the client sending the requested content sequence to the current server network address.

25. One or more processor readable storage devices having processor readable code embodied on said processor readable storage devices, said processor readable code for programming one or more processors to perform a method of recovering an Internet data packet transmission session, after resolution of a network disruption, in a session between a client having a client network address and a server having a server network address, the server receiving the content sequences from the client in response to explicit requests for the content sequences, wherein the network disruption is caused by loss of connectivity between the client and server or by network address relocation of either of the client or the server, and wherein the data packets include content sequence, a session identifier signal for identifying the session and a beacon signal associating the session identifier signal with the client network address, the recovery process comprising:
the client sending the beacon signal to the client in response to the client failing to receive an expected request from the server for content sequence.
